(19) United States
(12) Patent Application Publication
(10) Pub. No.: US 2006/0246188 A1
(43) Pub. Date: Nov. 2, 2006

(54) Method for preparing tomato sauce using convective heating and sauce and pasta products produced thereby

(75) Inventors: Jorge K. Succar, Yorba Linda, CA (US); Christopher M. Branda, Lewisburg, PA (US); James W. Belleson, Lewisburg, PA (US)

Correspondence Address: Bingham McCutchen LLP, Suite 1800, Three Embarcadero Center, San Francisco, CA, 94111-4067, US

(73) Assignee: CONAGRA GROCERY PRODUCTS COMPANY, a Delaware Corporation, Irvine, CA (US)

(21) Appl. No.: 11/117,688

(22) Filed: Apr. 27, 2005

(51) Int. Cl. C08G 59/42

(52) U.S. Cl. 426/131

(57) ABSTRACT

A method for producing tomato sauce and food items including a tomato sauce, and the products produced thereby. A tomato sauce is produced by mixing a paste and other necessary ingredients. The paste mixture is extruded cold, forming a plurality of cold paste mixture portions, which are placed in a container. Heated water is added to the container. The heated water convectively heats the paste mixture portions, thereby forming a sauce. The container can also include a pasta item, such as ravioli so that the resulting sauce is applied to the ravioli.

### FIELD OF THE INVENTION

The present invention relates generally to methods for making sauces and, more particularly, to methods for making a tomato sauce by exposing the sauce ingredients to reduced heat and thermal stress by convectively heating sauce ingredients in water.

### BACKGROUND

Traditionally, conductive heating has been used to prepare sauces for processed and packaged food items such as, for example, tomato sauce for ravioli and other packaged pasta products. In one known process, a batch of a pourable or liquid-like tomato puree and hot water at a temperature of about 140° F. are mixed with other sauce ingredients in an open kettle. The ingredients are heated to about 200° F. and held and mixed together in the kettle for about 30 minutes, producing a tomato sauce. The kettle-made tomato sauce is added to a can that includes ravioli or other pasta. Hot water is added to the container having the tomato sauce and ravioli, and a top is applied to the container with a seamer. The sealed container is exposed to heat to sterilize the contents in the container.

Known tomato sauce production and related food item preparation methods, however, can be improved. For example, as a result of the conductive “open kettle” heating, tomato sauces are exposed to prolonged durations of high heat and temperatures. Prolonged exposure to heat boils or cooks away flavorings and aromas of the sauce. Open kettle heating can also impair the texture and color of the sauce. Thus, conductive open kettle heating negatively impairs various aspects of the tomato sauce, resulting in a lower quality tomato sauce with diminished taste, aroma, color and texture.

Additional heating of the sealed product may be required to sterilize the contents of the container. In known sterilization processes, heat is directed to the outer walls of the sealed container or can. As a result, heat must pass through walls of the can and the prepared food product to reach the middle portions of the food product inside the can. Thus, food product is exposed to even more heat and thermal stress, which can further negatively impact flavorings and aromas of the sauce inside the can. An additional drawback is that sterilization can be inconsistent since portions of the food product near the body of the can are heated more than the portions of the food product in the middle of the can.

Accordingly, there exists a need for improved method of making sauce for processed or packaged pasta products that does not require kettle or conductive heating, subjects the sauce to reduced thermal stresses, protects the texture, color, flavor and aromas of the sauce, and provides sufficient heat to sterilize the food product.

### SUMMARY

In accordance with one embodiment is a method of making a tomato sauce. A plurality of sauce ingredients, including a tomato paste, are mixed together to form a paste mixture. The paste mixture is extruded to form individual paste mixture portions, which are placed in a container. Heated water is added to the container, and the heated water convectively heats the extruded paste mixture portions so that they are dissolved in the heated water to form a tomato sauce.

In accordance with an alternative embodiment is a method of making a pasta product that includes a tomato sauce. A plurality of sauce ingredients including a tomato paste are mixed together to form a tomato paste mixture. The tomato paste mixture is extruded to form individual tomato paste mixture portions, which are placed into a container. A pasta item is also placed in a container. Heated water is added to the container to convectively heat and dissolve the extruded tomato paste mixture portions, thereby forming a tomato sauce, which is applied to the pasta item inside the container.

In a further alternative embodiment is a packaged pasta that includes a tomato sauce. The product includes a container, an extruded tomato paste mixture, a pasta item, and heated water. The extruded tomato paste mixture, the pasta item and the heated water are added to the container, and the heated water convectively heats the extruded tomato paste mixture so that the extruded tomato paste mixture dissolves, thereby forming a tomato sauce that is applied to the pasta item inside the container.

In various embodiments, the tomato paste can be an undiluted tomato paste having a concentration of about 36 brix. The tomato paste mixture can have about 50 wt. % tomato paste, and the tomato paste has about 36 wt. % solids.

Mixing, extruding and adding heated water steps are advantageously performed without conductive heating (e.g., kettle heating).

Depending on the size of the container, about three to five extruded paste mixture portions are placed into the container. The extruded portions can have various shapes and sizes, including spherical and cube shaped portions. The extruded portions can be about ⅜″ to about ⅞″ in width or diameter. Extruded paste mixture portions can be directly into the container or placed into a container after being transported, e.g., on a conveyor.

In embodiments involving a pasta ingredient, the pasta can be ravioli and may include a filling. According to one embodiment, a pasta product includes about 1 part extruded tomato paste mixture portions, about 2 parts pasta item and about 4 parts heated water, based on a weight of the ingredients.

### BRIEF DESCRIPTION OF THE DRAWINGS

Referring now to the drawings, in which like reference numbers represent corresponding parts throughout, and in which:

FIG. 1 is a flow diagram of a process for making a tomato sauce with reduced thermal stress according to one embodiment;

FIG. 2 is a diagram of a system for making sauce that includes an extruder that is an element of or coupled to a mixer, and formed sauce mixture portions being placed directly into containers according to one embodiment;

FIG. 3 is a diagram of a system for making sauce that includes an extruder that receives a sauce mixture from a mixer and provides formed sauce mixture portions directly into containers according to one embodiment;

FIG. 4 is a diagram of a system for making sauce that includes an extruder that receives a sauce mixture from a mixer and provides formed sauce mixture portions to a conveyor, which delivers the portions to containers according to one embodiment;

FIG. 5 is a flow diagram of a reduced thermal stress process for making a pasta product that includes a pasta item and a tomato sauce according to one embodiment;

FIG. 6 is a diagram of a system for making a pasta product having sauce that includes an extruder that is an element of or coupled to a mixer, and formed sauce mixture portions and pasta being placed directly into containers according to one embodiment;

FIG. 7 illustrates sauce mixture portions having a generally spherical shape according to one embodiment;

FIG. 8 is a perspective view of sauce mixture portions in a container;

FIG. 9 illustrates sauce mixture portions having a generally cubical shape according to another embodiment;

FIG. 10 illustrates heated water being added to sauce mixture portions in the container shown in FIG. 9;

FIG. 11 illustrates the sauce mixture portions at least partially liquefying as a result of exposure to heated water;

FIG. 12 illustrates a sauce resulting from the combination of sauce mixture portions and heated water;

FIG. 13 illustrates sauce mixture portions and pasta added to a container;

FIG. 14 illustrates heated water added to the sauce mixture portions and pasta;

FIG. 15 illustrates the sauce mixture portions at least partially liquefying as a result of exposure to the heated water; and

FIG. 16 illustrates a combination of a sauce and pasta resulting from the combination of sauce mixture portions, heated water and pasta.

### DETAILED DESCRIPTION OF ILLUSTRATED EMBODIMENTS

Embodiments of the invention are directed to methods of making sauce, sauce products and pasta products including a sauce, in which the sauce is advantageously prepared by convective heating, rather than known conductive or kettle heating. As a result, the heating of the sauce ingredients is done in a more thermally efficient manner so that the resulting sauce maintains more flavorings, aromas, color and texture compared to sauces that are prepared using known conductive or kettle heating methods and systems. Sauces prepared with embodiments can be separately packaged or packaged with a pasta product, such as ravioli. The sauce and sauce-containing products can also be heat sterilized faster than conventional products, thus reducing processing and sterilization times and costs.

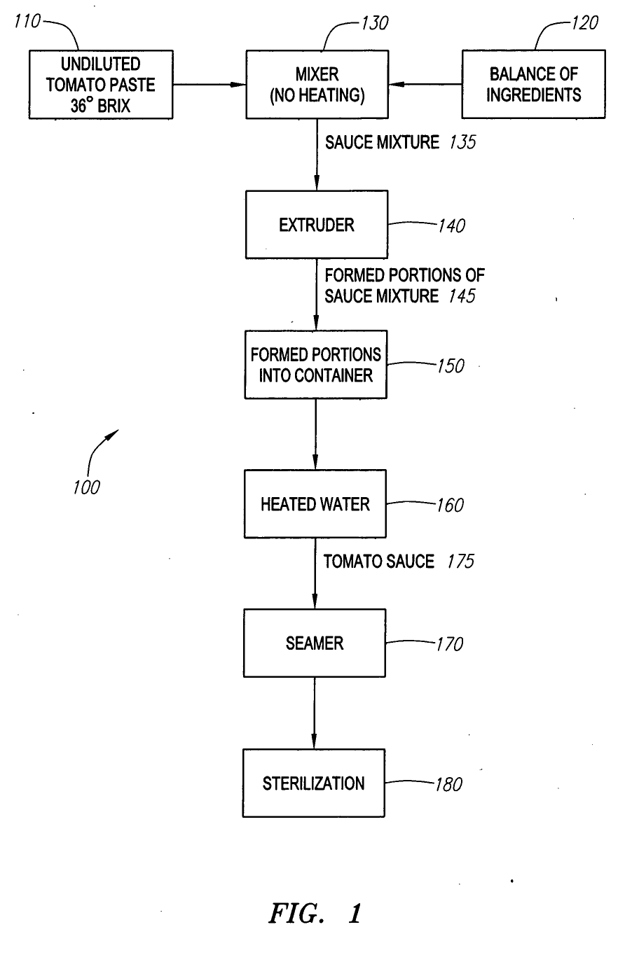

FIG. 1 illustrates one embodiment of a method 100 for producing a tomato sauce 175. Undiluted tomato paste 110 and other ingredients 120 are added to a mixer 130. The tomato paste 110 can be, for example, an undiluted or concentrated tomato paste have a concentration of about 24-42 brix or degree brix (generally “brix”) e.g., about 36 brix. Brix indicates the amount of sugar or soluble solids in tomato paste and is defined as soluble solids per 10 g of paste. The tomato paste 110 is thicker and more viscous than tomato purees that are used in known sauce processing methods. The tomato paste 110 is flowable or pumpable, but generally not pourable or liquid-like as is a tomato puree.

Other ingredients 120 that are added to the mixer 130 can include, for example, other vegetables, such as onions, carrots and peas, meats, such as beef and pork, and various flavorings, such as salt, pepper, garlic, oregano, parsley, basil and bay. Persons skilled in the art will appreciate that the tomato paste 110 and the other ingredients 120 can be selected to taste or to prepare different food products, such as pasta products and other food items that include tomato or like sauces. For purposes of illustration and explanation, not limitation, this specification primarily refers to tomato sauce and pasta products that contain a tomato sauce, in particular, packaged or canned ravioli products.

The tomato paste 110 and other ingredients 120 are mixed together in the mixer 130 to form a paste mixture 135. The temperature of the paste mixture 135 can be about 35-75° F. In other words, the sauce mixture 135 is “cool” or “cold”. Thus, it is not necessary to heat the paste mixture 135 during or after mixing, unlike known open kettle heating and mixing.

The paste mixture 135 is provided to an extruder 140. One suitable extruder 140 that can be used is a extruder Model No. S40-25-DCO Filler, available from Preferred Machining Corporation, Englewood, Colo. Persons skilled in the art will appreciate that other extruders can also be used, such as other extruders available from Preferred Machining Corporation and extruders available from Bridge Corporation.

The extruder 140 forms a plurality of individual portions 145 of the paste mixture 135. The temperature of the formed portions 145 is the same or similar to the temperature of the sauce mixture 135 in the mixer 130. In other words, the formed portions are “cool” or “cold”, and it is not necessary to heat the paste mixture 130 inside the extruder 140. In the illustrated embodiment, the formed portions 145 are placed into a can or other container 150, such as a plastic or metal can or container (generally “container”). The container can be microwaveable.

Heated water 160 is added to the container that includes the formed portions 145. Persons skilled in the art will appreciate that the heated water 160 can be added to the container before or after the formed portions 145 are added to the container. The container with the heated water and sauce portions 145 is sealed or topped with a seamer 170 or other suitable sealing device, and sterilized 180 to effect microbial kill. The heated water 160 and the formed paste portions 145 mix together to form a tomato sauce 175. In other words, the formed paste portions 145 at least partially liquefy and mix with the water 160, thereby forming a tomato sauce 175. For example, when using a 7.5 ounce microwaveable container, a paste ball may sufficiently liquefy and mix with the water when heated by the water for about 12 minutes. If necessary, the container may be agitated to facilitate this process. For example, agitation may be helpful when denser tomato sauces mixtures are or larger containers are utilized.

The concentration or density of the tomato paste 110 can be selected so that a consistent tomato sauce 175 is produced after the paste 110 is exposed to heated water 160 for a certain amount of time. The paste 110 should not be too dense given an amount of heated water 160 since the paste 110 will not completely mix with the water 160 to form a sauce 175. On the other hand, the paste 110 should not be too thin so that the resulting sauce 175 is too watery.

Tomato paste 110 having about 36 brix has been found to be satisfactory when the paste is formed or extruded into portions or balls 145 weighing about 0.4 ounce to about 0.75 ounce and when about 3.5 ounces to about 10 ounces of water at a temperature of about 140° F. is placed in a container having a volume of about 7.5 ounces to about 15 ounces. Persons skilled in the art will appreciate that the concentration and amount of the tomato paste 110 paste (e.g., sizes of the portions 145), the amount and temperature as of the water 160, and the volume of the container can be adjusted as necessary so that the mixture of the paste 110 and heated water 160 results in a tomato sauce 175 that possesses the desired thickness and consistency.

Further, if necessary, individual packages can be shaken or stirred in order to ensure that no agglomerated paste 110 remain after hot water 160 is added to the container with the formed paste portions 145. This may be necessary when, for example, the concentration of the paste 110 is slightly higher than what is needed, or the quantity of heated water 160 is slightly less than what is needed. The paste is thus advantageously heated using hot water 160 to convectively heat the formed paste portions 145, as opposed to mixing and conductively heating ingredients in an open kettle as in known processes.

Convective heating according to embodiments can occur before, during and after sterilization 180 since the heated water 160 will require some time to cool and will continue to interact with the paste portions 145. In other words, the convective heating effect can continue so long as the water 160 releases heat or energy to liquefy and mix with the formed paste portions 145 until a thermal equilibrium is achieved inside the container. The time to produce sauce products with convective heating is estimated to be about 30% faster than sauce production methods that use conductive kettle heating.

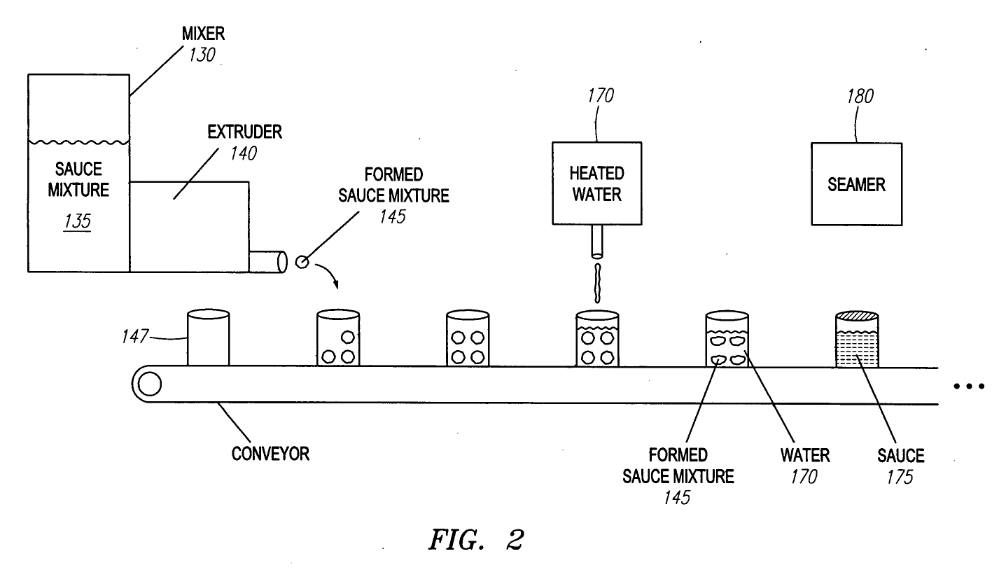

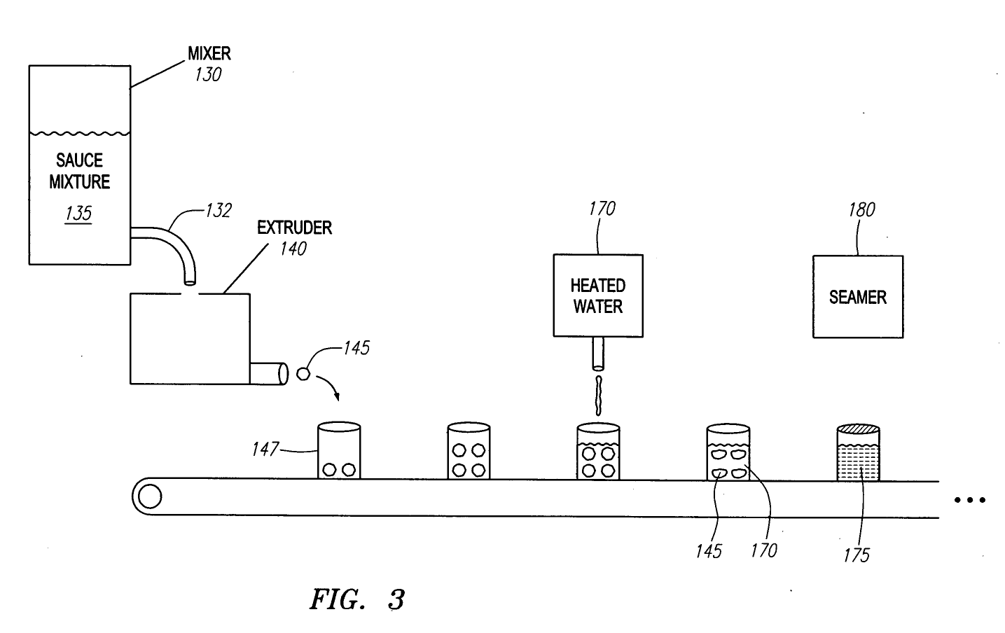

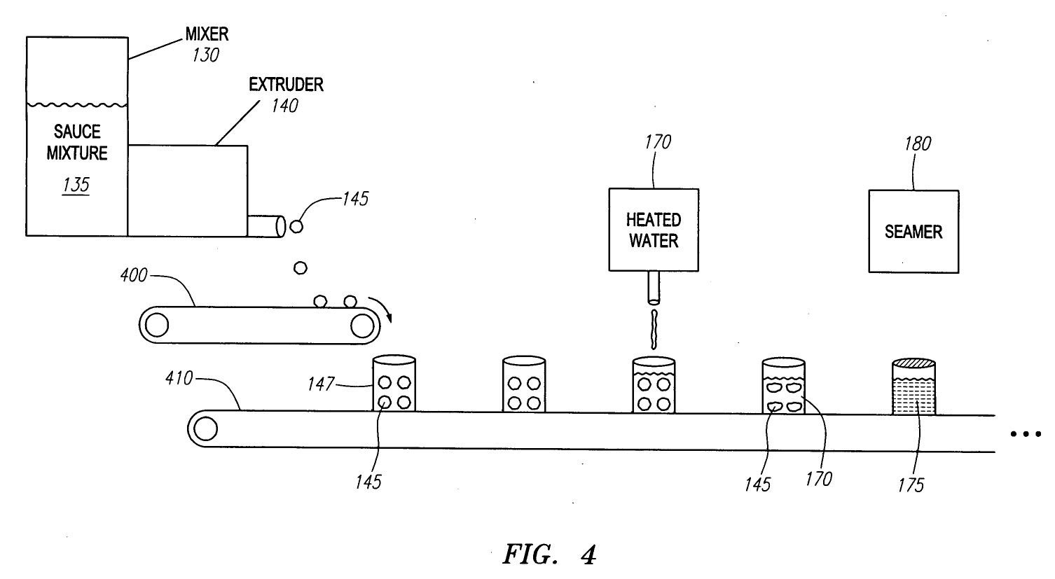

Referring to FIG. 2, the extruder 140 can be an element of the mixer 130 or coupled to the mixer 130. The formed paste mixture portions 145 can be provided directly into a container 147. Alternatively, as shown in FIG. 3, the paste mixture 135 can be emptied from the mixer 130 and provided to the extruder 140 through a conduit 132. In a further embodiment, as shown in FIG. 4, the formed paste mixture portions 145 can drop down onto a first conveyor 400, which carries the portions 145 to containers 147 carried by a second conveyor 410. The second conveyor 410 carries the containers 147 to the heated water 160, seamer 170 and sterilization 180 stations. Other configurations can also be utilized, e.g., a combination of the configuration shown in FIGS. 2 and 4, a combination of the configuration shown in FIGS. 3 and 4. For purposes of illustration and explanation, not limitation, this specification primarily refers to the configuration shown in FIG. 2.

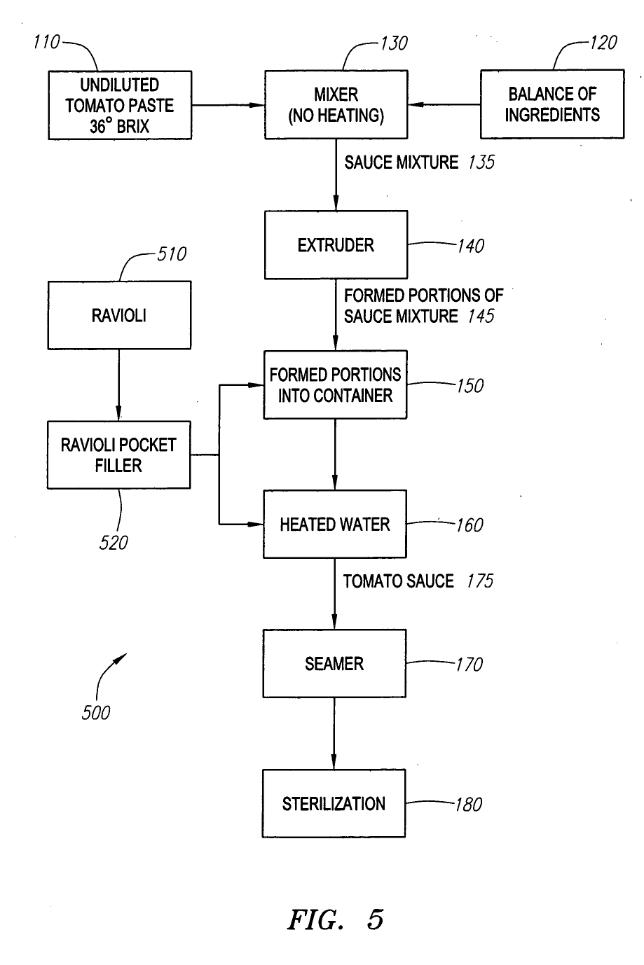

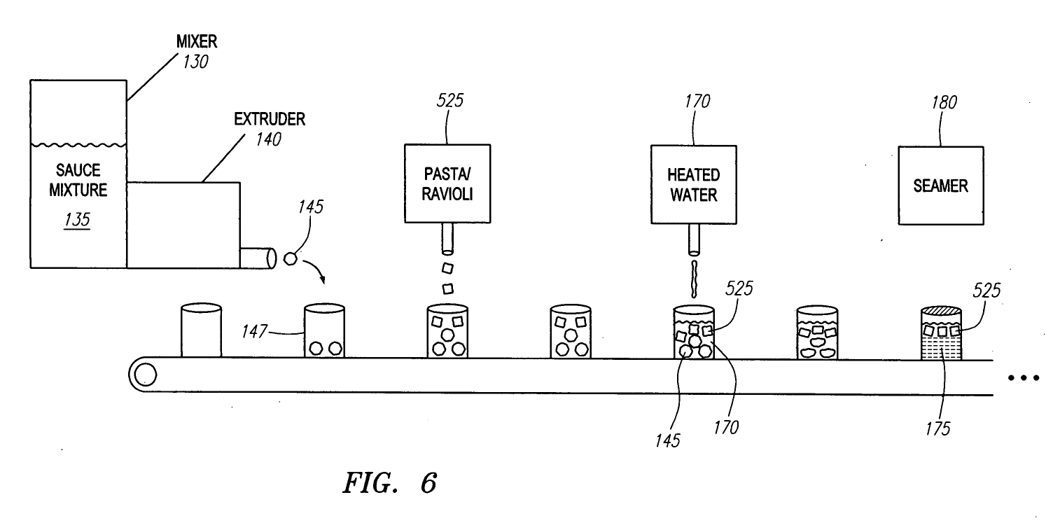

Referring to FIGS. 5 and 6, in an alternative embodiment, a pasta item can be included with the formed paste portions 145 and heated water 160 in a container to form a packaged or canned pasta food product that includes a tomato sauce. More particularly, as previously discussed, the tomato paste 110 is added with other ingredients 120, mixed 130 and extruded 140 as individual portions 145 of a sauce mixture. In addition, a pasta food item is added into the container. In the illustrated embodiment, the pasta item is ravioli 510. If necessary the ravioli 510 is filled 520 with a meat or meat substitute filler to form a stuffed ravioli 510. The container 147 having the formed paste portions 145, ravioli 510 and heated water 160 is then sealed with a seamer 170 and sterilized 180 to effect microbial kill.

Similar to the process described with reference to FIG. 1, the heated water 160 and the formed paste mixture portions 145 mix together, thereby forming a tomato sauce 175. Thus, the sauce 175 is prepared using heated water 160 to convectively heat the formed paste portions 145, as opposed to mixing and conductively heating sauce in an open kettle. With movement of the containers during, for example, distribution and re-positioning, the ravioli 510 and the sauce 175 may mix together further, if necessary, so that the sauce 175 covers all of the ravioli 510. Convective heating can take place before, during and after sterilization 180 since the heated water will require some time to cool and reach an equilibrium. The sauce 175 partially or completely covers the ravioli 510.

As with the embodiment shown in FIG. 1, the concentration or density of the tomato paste 110 can be selected so that a consistent tomato sauce 175 is produced after the paste 110 is exposed to heated water 160 for a certain amount of time. Undiluted tomato paste 110 having about 36 brix has been found to be satisfactory when the paste is formed or extruded into portions or balls 145 weighing about 0.4 ounce to about 0.75 ounce, with about 3.5 ounces to about 10 ounces of water at a temperature of about 140° F. placed in a container having a volume of about 7.5 to about 15 ounces with about 2-4.5 ounces of ravioli. Persons skilled in the art will appreciate that the concentration and amount of the tomato paste 110 paste (e.g., sizes of the portions 145), the amount and temperature as of the water 160, the volume of the container and quantity of ravioli can be adjusted as necessary so that the mixture of the paste 110 and heated water 160 results in a tomato sauce 175 that possesses the desired thickness and consistency.

For example, in one embodiment, a container 147 having a volume of about 7.5-15 ounces includes about 1.12 ounces of tomato paste 110, about 2.12 ounces of ravioli 510, and about 4.31 ounces of heated water 160 at about 140° F., roughly ratios of 1:2:4 or 1 part tomato paste 110 to 2 parts ravioli 510 to 4 parts water 160, based on the weight of these ingredients. The ratio of the paste 110 (which is about 36 wt. % solids) to other ingredients 120 is about 50/50, e.g., about 48/52. The concentration and amount of the paste 110, the amount of ravioli 510, the amount and temperature of the water 160, and volume of the container 147 can be adjusted as necessary so that a tomato sauce 175 with desired viscosity and consistency characteristics is produced.

Persons skilled in the art will appreciate that the ravioli 510 may include other fillers 520 or no fillers. In other words, the pasta item may be plain pasta. Further, the pasta item can be various shapes and sizes. For example, one exemplary form of ravioli 510 is a “square” shaped pocket. Other pasta items, such as noodles, macaroni and other shaped pastas, can also be utilized to prepare different food items that include a tomato sauce. For purposes of explanation, those specification refers to a stuffed or filled ravioli 525.

As shown in FIGS. 5 and 6, the ravioli 525 is added to the container 147 after the formed paste mixture portions 145 are initially added to the container 147. Heated water 160 is then provided over the ravioli 525 and the paste mixture portions 145. Process embodiments, however, may be performed in different orders. For example, the ravioli 525 can be added first, then the paste mixture portions 145, and then the heated water 160. Alternatively, the ravioli 525 can be added first, then the heated water 160, and then the paste mixture portions 145. Further, the formed portions 145 can be added first, then the heated water 160, then the ravioli 525. Alternatively, the heated water 160 can be added first, then the ravioli 525, then the formed paste portions 145, or the heated water 160 first, followed by the formed paste portions 145 and then the ravioli 525. Accordingly, the illustrated embodiments are not intended to be limiting in terms of the order of certain processing steps.

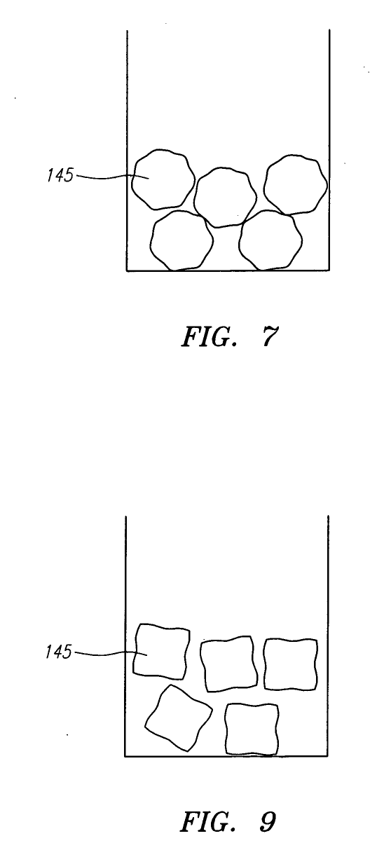

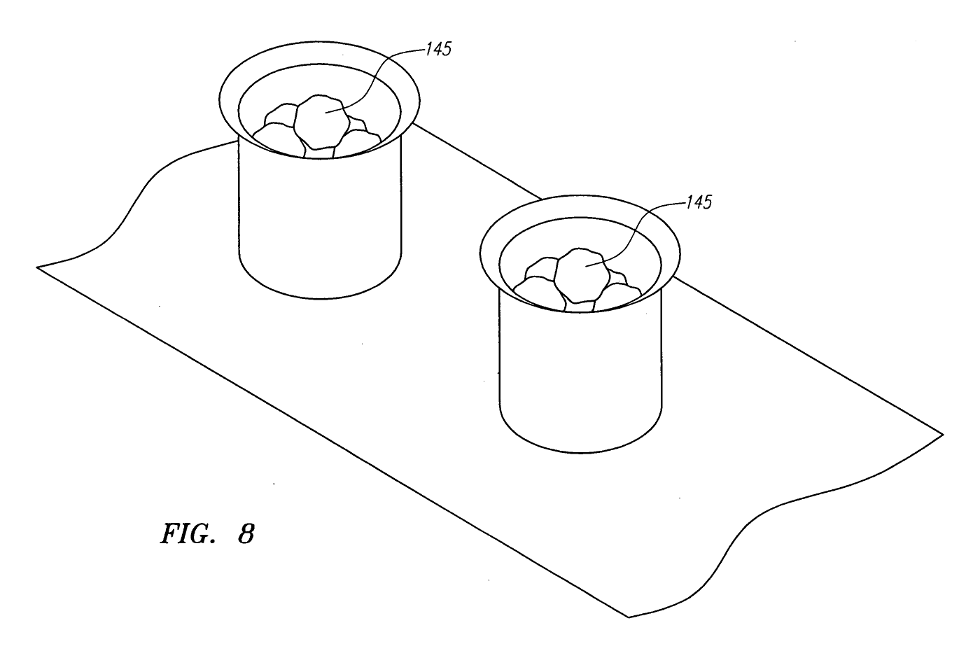

Referring to FIGS. 7 and 8, the formed paste portions 145 can have a generally spherical or ball-like shape. Different shaped portions 145 can be formed with different extruder 140 configurations, as is known in the art. The number of formed portions 145 a container 147 receives can depend on, for example, the size of the container 147, the size of the paste balls 145 and whether pasta items or ravioli 525 and other ingredients 120, are included in the container 147.

Referring to FIG. 9, in an alternative embodiment, the formed paste portions 145 can have a square or cube shape. Other shapes can also be utilized with appropriate changes to the extruder 140. Further, the formed portions can have various sizes, e.g., about ⅜″ to about ⅞″ in width or diameter.

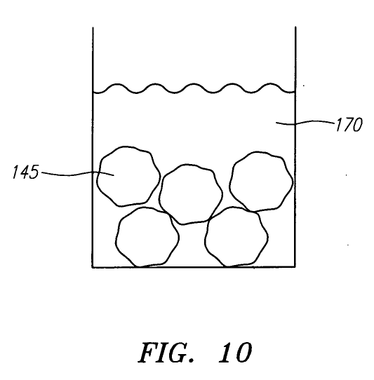

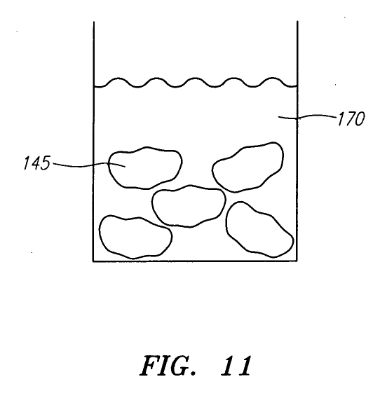

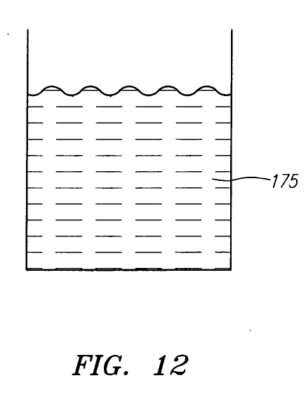

FIGS. 10-12 illustrate the interaction of the formed paste portions 145 and heated water 160 in further detail. Referring to FIG. 10, heated water 160 is initially added over the formed paste portions 145. The ratio of water 160 to paste portions 145 can be about 2:1 to about 5:1, based on a weight of these ingredients. The water can have a temperature of about 100° F. to about 170° F. Referring to FIG. 11, the formed paste portions 145 begin to liquefy or mix with the water 160 as a result of the convective heating from the water 160. Referring to FIG. 12, the formed paste portions 145 eventually mix with the heated water 160, forming a sauce 175. Thus, when producing a packaged food item, the paste or ingredient ball can be added to the package, and water and ravioli are added. The package can then be seamed and sterilized. During this process, the past ball dissolves in the water and becomes sauce.

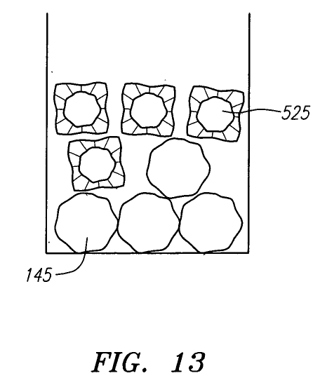

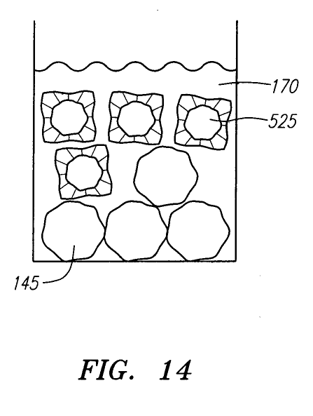

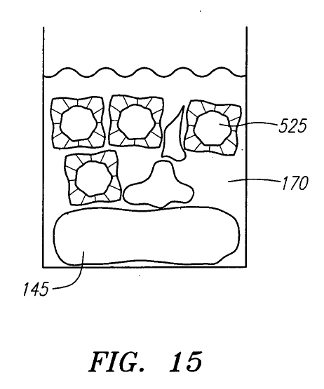

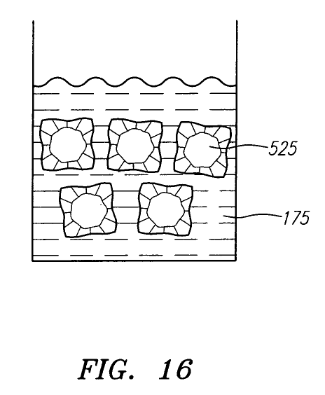

FIGS. 13-16 illustrate similar steps with regard to a container having both ravioli 525 and formed sauce portions 145. As shown in FIG. 13, the ravioli 525 and formed paste portions 145 are added to a container 147. Referring to FIG. 14, heated water 160 is added to the container 147. In the illustrated embodiment, the heated water 160 covers both the ravioli 525 and the paste portions 145, but different amounts of heated water 160 may be used depending on, for example the amount of ravioli 525 and paste portions 145, the shape and size of the container 147, and the temperature of the water 160. Referring to FIG. 15, the formed paste portions 145 begin to mix with the water 160 as a result of convective heating. FIG. 16 illustrates the resulting tomato sauce 175 formed by the combination of the formed paste portions 145 and heated water 160, together with the ravioli 525 in the container 147. The container 147 may then be sealed 170 and sterilized 180.

Embodiments using convective heating provide a number of benefits relative to known “open kettle” processing systems and methods. For example, conductive kettle heating is eliminated altogether. Instead, convective heating with water is utilized to provide a tomato sauce with improved taste, flavoring, color and texture since if the sauce ingredients are exposed to less intense heat for shorter durations of time. In other words, the ingredients are not “burned off” as they are in “open kettle” conductive heating.

Convective heating is also faster since the heat transfer characteristics of water allow the food items, such as ravioli, to be heated in a more efficient manner, while exposing the food items to less thermal stress than traditional conductive kettle heating. Further, embodiments allow for more effective and faster sterilization of sealed containers since the ravioli to be sterilized are initially in water before the water and sauce portions mix together to form a tomato sauce. Thus, the same sterilization effect can be achieved with reduced sterilization times since the ravioli are heated more quickly in water. In contrast, longer sterilization times are required in other known processes since the ravioli is always mixed together with a sauce.

Persons skilled in the art will recognize that embodiments can be used to prepare tomato sauces for various food items. For example, embodiments can be used to prepare sauces in various Chef Boyardee brand products. This specification refers to ravioli food products as an example, however, persons skilled in the art will appreciate that embodiments can be used to prepare various other food and pasta products that include tomato sauce or tomato products as an ingredient. Further, persons skilled in the art will appreciate that various parameters can be adjusted to accommodate different ingredients, food items, and containers. For example, the size, shape, concentration and quantity of the pasta mixture portions, the quantity and temperature of the water, the quantity of pasta or other food items, and the shape and size of the container can all be adjusted as needed in order to produce a desired sauce or a desired pasta product that includes a sauce.

What is claimed:

1. A method of making a tomato sauce, comprising:
providing a plurality of sauce ingredients, the sauce ingredients including a tomato paste;
mixing the plurality of sauce ingredients together to form a paste mixture;
extruding the paste mixture to form a plurality of individual paste mixture portions, wherein the extruded paste mixture portions are placed into a container;
adding heated water to the container, the heated water convectively heating the extruded paste mixture portions so that the extruded paste mixture portions are dissolved in the heated water to form a tomato sauce.

2. The method of claim 1, wherein providing the tomato paste comprises providing an undiluted tomato paste having a concentration of about 36 brix.

3. The method of claim 1, wherein mixing is performed at an ambient temperature in the absence of additional heat.

4. The method of claim 1, wherein the tomato paste mixture has about 50 wt. % tomato paste, and wherein the tomato paste has about 36 wt. % solids.

5. The method of claim 1, wherein the extruded paste mixture portions are placed directly into the container.

6. The method of claim 1, wherein the extruded paste mixture portions are transported and then placed into the container.

7. The method of claim 1, wherein about three to five extruded paste mixture portions are placed into the container.

8. The method of claim 1, wherein extruding comprises forming generally spherical-shaped paste mixture portions.

9. The method of claim 1, wherein extruding comprises forming generally cube-shaped paste mixture portions.

10. The method of claim 1, wherein the mixing, extruding and adding steps are performed without conductive heating.

11. The method of claim 10, wherein the mixing, extruding and adding steps are performed without heating in a kettle.

12. The method of claim 1, wherein extruding comprises extruding the paste mixture to form a plurality of individual paste mixture portions that have a temperature of about 35-75° F.

13. The method of claim 1, wherein adding heated water comprises adding water at a temperature of about 100° F. to about 170° F.

14. The method of claim 1, wherein the extruded paste mixture portions have a width or diameter of about ⅜″ to about ⅞″.

15. A method of making a pasta product that includes a tomato sauce, comprising:
providing a plurality of sauce ingredients including a tomato paste;
mixing the plurality of sauce ingredients together to form a tomato paste mixture;
extruding the tomato paste mixture to form a plurality of individual tomato paste mixture portions;
placing the extruded tomato paste mixture portions into a container;
placing a pasta item into the container;
adding heated water to the container to convectively heat and dissolve the extruded tomato paste mixture portions in the container to form a tomato sauce, wherein the tomato sauce is applied to the pasta item inside the container.

16. The method of claim 15, wherein providing the tomato paste comprises providing an undiluted tomato paste having a concentration of about 36 brix.

17. The method of claim 15, wherein mixing is performed at an ambient temperature in the absence of additional heat.

18. The method of claim 15, wherein the tomato paste mixture has about 50% tomato paste, and wherein the tomato paste has about 36 wt. % solids.

19. The method of claim 15, wherein the extruded tomato paste mixture portions are placed directly into the container.

20. The method of claim 15, wherein the extruded tomato paste mixture portions are transported and then placed into the container.

21. The method of claim 15, wherein about three to five extruded tomato paste mixture portions are placed into the container.

22. The method of claim 15, wherein extruding comprises forming generally spherical-shaped tomato paste mixture portions.

23. The method of claim 15, wherein extruding comprises forming generally cube-shaped tomato pastes mixture portions.

24. The method of claim 15, wherein the mixing, extruding and adding steps are performed without conductive heating.

25. The method of claim 24, wherein the mixing, extruding and adding steps are performed without heating in a kettle.

26. The method of claim 15, wherein extruding comprises extruding the paste mixture to form a plurality of individual paste mixture portions that are at a temperature of about 35-75° F.

27. The method of claim 15, wherein adding heated water comprises adding water at a temperature of about 100° F. to about 170° F.

28. The method of claim 15, wherein the extruded tomato paste mixture portions have a width or diameter of about ⅜″ to about ⅞″.

29. The method of claim 15, wherein the pasta item is ravioli.

30. The method of claim 15, wherein the pasta item includes a filling.

31. The method of claim 15, wherein the pasta product includes
about 1 part of the extruded tomato paste mixture portions;
about 2 parts of the pasta item; and
about 4 parts of the heated water,
wherein the portions are based on a total weight of the extruded tomato paste mixture, the paste item and the heated water ingredients.

32. A packaged pasta product that includes a tomato sauce, comprising:
a container;
an extruded tomato paste mixture;
a pasta item; and
heated water,
wherein the extruded tomato paste mixture, the pasta item and the heated water are added to the container, and the heated water convectively heats the extruded tomato paste mixture so that the extruded tomato paste mixture dissolves, thereby forming a tomato sauce that is applied to the pasta item inside the container.

33. The packaged pasta product of claim 32, wherein the extruded tomato paste mixture includes an undiluted tomato paste having a concentration of about 36 brix.

34. The packaged pasta product of claim 32, wherein the extruded tomato paste mixture is mixed at an ambient temperature in the absence of additional heat.

35. The packaged pasta product of claim 32, wherein the extruded tomato paste mixture has about 50% tomato paste having about 36 wt. % solids.

36. The packaged pasta product of claim 32, wherein the extruded tomato paste mixture is placed directly into the container.

37. The packaged pasta product of claim 32, wherein the extruded tomato paste mixture is transported and then placed into the container.

38. The packaged pasta product of claim 32, wherein the extruded tomato paste mixture includes a plurality of individual tomato paste mixture portions.

39. The packaged pasta product of claim 38, wherein the packaged pasta product includes about three to five extruded tomato paste mixture portions.

40. The pasta product of claim 38, wherein the plurality of extruded tomato paste mixture portions are spherical-shaped portions.

41. The pasta product of claim 38, wherein the plurality of extruded tomato paste mixture portions are cube-shaped paste portions.

42. The pasta product of claim 38, wherein the plurality of extruded tomato paste mixture portions are have a width or diameter of about ⅜″ to about ⅞″.

43. The pasta product of claim 32, wherein the extruded tomato paste mixture has a temperature of about 35-75° F.

44. The pasta product of claim 32, wherein the pasta item is a ravioli.

45. The pasta product of claim 32, wherein the water has a temperature of about 100° F. to about 170° F.

46. The pasta product of claim 32, wherein the pasta item includes a filling.

47. The pasta product of claim 32, having about
about 1 part of the extruded tomato sauce mixture;
about 2 parts of the pasta item; and
about 4 parts of the heated water,
wherein the portions are based on a total weight of the extruded tomato paste mixture, the paste item and the heated water ingredients.
